(19) United States
(12) Patent Application Publication
(10) Pub. No.: US 2019/0268222 A1
(43) Pub. Date: Aug. 29, 2019

(54) METHOD AND PROVISIONING CONTROL SYSTEM OF A COMMUNICATION NETWORK FOR CONTROLLING PROVISIONING OF SERVICES FROM A PROVISIONING NETWORK TO COMMUNICATION DEVICES

(71) Applicant: Telefonaktiebolaget LM Ericsson (publ), Stockholm (SE)

(72) Inventors: Linus BJERSTEDT BLOM, Karlskrona (SE); Fredrik AHLIN, Karlskrona (SE); Doru CONSTANTINESCU, Karlskrona (SE); Teresa PASCUAL, Karlskrona (SE); Kelvin YOREME, Karlskrona (SE)

(21) Appl. No.: 16/308,952

(22) PCT Filed: Jun. 23, 2016
(86) PCT No.: PCT/SE2016/050619

§ 371 Date: Dec. 11, 2018

(51) Int. Cl. H04L 12/24; H04L 12/26

(52) U.S. Cl. CPC H04L 41/0806; H04L 43/0864; H04L 41/147; H04L 43/0882; H04L 43/0847

(57) ABSTRACT

A method is disclosed performed by a provisioning control system of a communication network, the provisioning control system controlling provisioning of services from a provisioning network of the communication network to communication devices belonging to subscribers of the communication network. The method includes determining transmission settings for a current transmission of control data from the provisioning control system to a node of the provisioning network, the control data controlling provisioning of services from the provisioning network to communication devices, wherein the transmission settings for the current transmission are determined based on transmission settings and transmission characteristics of one or more previous transmissions of control data from the provisioning control system to the provisioning network node. The method further includes triggering the current transmission of the control data to the provisioning network node according to the determined transmission settings.

### TECHNICAL FIELD

The present disclosure relates generally to a method and a provisioning control system of a communication network, the provisioning control system controlling provisioning of services from a provisioning network of the communication network to communication devices belonging to subscribers of the communication network.

### BACKGROUND

In a communication network, communication services, such as Voice over Long Term Evolution, VoLTE, are provisioned from a provisioning node, such as a VoLTE node of a core network, towards communication devices belonging to users subscribing to the communication service. The provisioning node is in its turn controlled by a provisioning control system, such as the proprietary Ericsson Multi-activation, EMA, product provided by the applicant. The provisioning control system sends control data to the provisioning node for controlling the provisioning of the services provided by the provisioning node to the communication devices. For example, if a user has started to subscribe to a service, the provisioning control system is informed of the new subscription from a business support system of the communication network. In response to the information from the business support system, the provisioning control system instructs the provisioning node to start providing the service to communication devices of the user.

At some occasions, a plurality of control data need to be sent to the provisioning node, for example when a new service has been launched or when a service level of a service has been changed. Then a batch of control data are sent from the provisioning control system to the provisioning node. Another example of when such a batch of control data are to be sent is when the latest sent control data need to be resent, which occurs for example at a power outage. This is called a replay provisioning, RP, operation. During an RP operation, new and ongoing service orders from the provisioning control system towards the provisioning node are blocked. This is performed in order to avoid race conditions between new service orders and service orders that are subject to RP. Once a RP request has been accepted for a given time span, it is crucial to complete the full request, i.e. to “replay” the complete time span, in order to capture all transitions of a subscriber for the given time span, or otherwise risk partial provisioning.

When a plurality of control data, such as in an RP operation, are to be sent to a provisioning node, the provisioning control system has a number of provisioning settings that controls the transmission of the plurality of control data to the provisioning node. In the example of an RP operation, the provisioning settings configure for example how long time an RP operation is allowed to run while at the same time blocking other provisioning requests, the length of an acceptable RP time span, for how long to perform provisioning retransmission, how many retransmissions that are allowed, for how long to keep ongoing/pending service orders alive, etc. Such provisioning settings are today predefined settings that are only manually modifiable. By having such more or less static provisioning settings, the provisioning settings have to be configured for worst case scenario and the system may thus reject other provisioning requests that it could have completed. As massive provisioning of control data occupies time for provisioning of other control data, such as when an RP provisioning needs to be completed before new control data is provisioned, it is of interest to make the provisioning of control data from a provisioning control system towards a provisioning node more efficient than what is possible with today's predefined settings.

### SUMMARY

It is an object of the invention to address at least some of the problems and issues outlined above. It is an object of embodiments of the invention to be able to efficiently provide a plurality of control data from a provisioning control system towards a provisioning node. It is possible to achieve one or more of these objects and possibly others by using a method and a provisioning control system as defined in the attached independent claims.

According to one aspect, a method is provided, performed by a provisioning control system of a communication network. The provisioning control system controls provisioning of services from a provisioning network of the communication network to communication devices belonging to subscribers of the communication network. The method comprises determining transmission settings for a current transmission of control data from the provisioning control system to a node of the provisioning network, the control data controlling provisioning of services from the provisioning network to communication devices, wherein the transmission settings for the current transmission are determined based on transmission settings and transmission characteristics of one or more previous transmissions of control data from the provisioning control system to the provisioning network node. The method further comprises triggering the current transmission of the control data to the provisioning network node according to the determined transmission settings.

According to another aspect, a provisioning control system is provided, operable in a communication network. The provisioning control system is configured for controlling provisioning of services from a provisioning network of the communication network to communication devices belonging to subscribers of the communication network. The provisioning control system comprises a processor and a memory. The memory contains instructions executable by said processor, whereby the provisioning control system is operative for determining transmission settings for a current transmission of control data from the provisioning control system to a node of the provisioning network, the control data controlling provisioning of services from the provisioning network to communication devices. The transmission settings for the current transmission are determined based on transmission settings and transmission characteristics of one or more previous transmissions of control data from the provisioning control system to the provisioning network node. The provisioning control system is further operative for triggering the current transmission of the control data to the provisioning network node according to the determined transmission settings.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a communication network in which the present invention can be used.

FIG. 2 is a flow chart illustrating a method performed by a provisioning control system, according to possible embodiments.

FIG. 3 is a schematic block diagram illustrating provisioning of a VoLTE service in a wireless communication network.

FIG. 4 is a signaling diagram illustrating an example of a method performed by a provisioning control system, according to further possible embodiments.

FIGS. 5-6 are block diagrams illustrating a provisioning control system in more detail, according to further possible embodiments.

### DETAILED DESCRIPTION

Briefly described, a solution is provided to efficiently transmit control data from a provisioning control system towards a provisioning node. This is achieved by adapting transmission settings for the transmission of the control data to the provisioning node based on earlier transmissions of control data from the provisioning control system to the provisioning node. In other words, transmission settings for a new transmission of control data are adapted to transmission settings of earlier transmissions of control data and to the result achieved from the earlier transmissions in terms of transmission characteristics, such as number of performed re-transmissions, number of simultaneous active connections, actual transmission rate and actual round-trip delay. Transmission settings and transmission characteristics from earlier transmissions may be stored in a storage reachable from the provisioning control system. The transmission settings for the new transmission may be determined based on the transmission settings and transmission characteristics of earlier transmissions using a machine learning algorithm that could be combined with a decision model support on the stored data. The control data transmitted from the provisioning control system are to be used by the provisioning node for provisioning of communication services to communication devices connected to the communication network. It is the transmission of the actual control data from the provisioning control system to the provisioning node that is controlled according to the present invention.

By such a solution, the provisioning control system will be able to predict e.g. how long it may take to perform a provisioning task. Also, predictions of configuration settings, such as connection pools, timeouts, etc. can be obtained. For example, transmission settings can be dynamically adapted to earlier response times when earlier control data were transmitted from the provisioning control system towards the provisioning node.

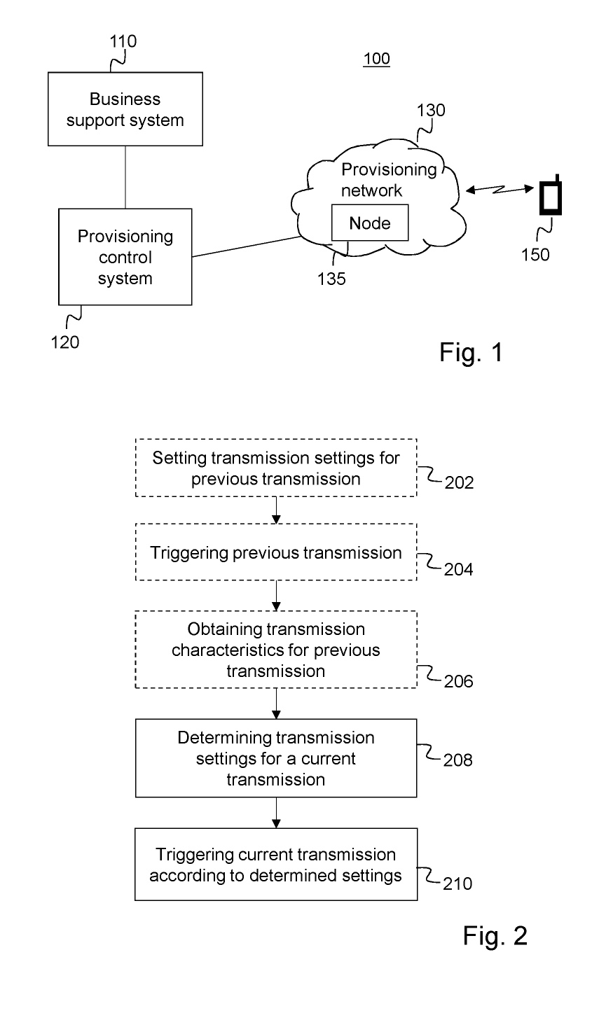

FIG. 1 shows a communication network 100 in which the present invention may be used. The communication network 100 comprises a business support system 110 connected to a provisioning control system 120. The provisioning control system 120 is in its turn connected to a provisioning network 130. In case of a wireless communication network, the provisioning network may be one or more of a core network, a radio access network and an operation and maintenance network. In the business support system 110, sales orders originating from subscribers of the operator, hereinafter called users, are processed into multiple work orders, or service orders. The service orders are sent to the provisioning control system 120 in which the service orders are transformed into provisioning control data controlling provisioning of the services towards communication devices of the users. The provisioning control data are sent to a node 135 of the provisioning network 130. The provisioning network 130 provides the service towards communication devices 150 of the users that subscribes to the service according to the received control data. In case of a wireless communication network, as shown in FIG. 1, the services are provisioned to wireless communication devices through a core network and a radio access network comprising base stations that transmit wireless signals towards the wireless communication devices 150. The core network and the radio access network may operate according to any known wireless communication standard. However, the communication network may also be a wireline communication network in which the provisioning network communicates the services towards communication devices connected via wireline towards the provisioning network. In such a communication network, the transmission of service provisioning control data from the provisioning control system 120 to a node 135 of the provisioning network 130 is controlled according to any of the embodiments of the invention described in this disclosure.

According to an embodiment shown in FIG. 2, in conjunction with FIG. 1, a method is provided, performed by a provisioning control system 120 of a communication network 100, the provisioning control system controlling provisioning of services from a provisioning network 130 of the communication network 100 to communication devices 150 belonging to subscribers of the communication network. The method comprises determining 208 transmission settings for a current transmission of control data from the provisioning control system to a node 135 of the provisioning network, the control data controlling provisioning of services from the provisioning network to communication devices 150. The transmission settings for the current transmission are determined based on transmission settings and transmission characteristics of one or more previous transmissions of control data from the provisioning control system 120 to the provisioning network node 135. The method further comprises triggering 210 the current transmission of the control data to the provisioning network node 135 according to the determined transmission settings.

Transmission settings for a previous transmission are settings used when control data was transmitted in the previous transmission from the provisioning control system to the provisioning network node. Transmission characteristics for the previous transmission are characteristics of the transmission that occurred for the previous transmission when using the transmission settings for the previous transmission. I.e. the transmission characteristics may be obtained from the network as a result of using the transmission settings for the previous transmission when transmitting the control data in the previous transmission. Transmission settings for a current transmission are settings to be used for a new transmission that is about to be performed. The provisioning network node may be any node providing the actual service, such as a multimedia application server node, e.g. a Multimedia Telephony Application Server, MTAS, Domain Name System, DNS, or a Policy and Charging Rules Function, PCRF. Alternatively, the provisioning network node may be a user database, such as a Centralized User Data Base, CUDB, or Home Subscriber Server, HSS. The control data sent may be a part of a Replay Provisioning task. The transmission characteristics as well as the transmission settings for a previous transmission may be stored at a storage unit reachable by the provisioning control system. The provisioning control system performing the method may be realized by one communication network node. Alternatively, the provisioning control system that performs the method may be realized by a group of network nodes, wherein functionality for performing the method are spread out over different physical, or virtual, nodes of the network. The latter may be called a “cloud-solution”. By determining the settings for an upcoming transmission of control data to the provisioning node based on settings and characteristics for earlier transmissions of control data, the settings can be more accurately set than what is possible today, which result in more efficient transmissions of control data to the provisioning node.

According to an embodiment, the transmission characteristics for the one or more previous transmissions comprises one or more of: previous network response times, number of performed re-transmissions, number of simultaneous active connections, actual transmission rate, actual round-trip delay, specific error response codes, characteristics of the payload that was sent, etc. Specific error response codes may indicate e.g. load protecting (try again later), or load distribution (try again towards a second provisioning node). Characteristics of the payload that was sent may include one or more of the following: the amount of payload that was sent, a measure defining how time-critical the payload was, if the payload was a CREATE, READ, UPDATE or DELETE operation, as well as complexity/size of the payload data, affecting the total processing time and round-trip time, etc. By determining the settings of the current transmission based on characteristics of previous transmissions such as number of performed re-transmissions, the settings for number of allowed re-transmissions for a current transmission can be adapted to the previously used number of re-transmission so that it becomes more streamlined. For example, if, for earlier transmissions, the number of used re-transmissions are two until a successful retransmission was reached or otherwise none of the further re-transmissions reached the provisioning network node, the number of allowed re-transmissions could be lowered to two or three. If the earlier settings for number of re-transmissions was five, it means that the total time for the transmission, if retransmissions have to be used, may be lowered.

According to another embodiment, the settings for the current transmission and the settings for the one or more previous transmissions comprises one or more of: maximum number of allowed re-transmissions for the control data, time period for waiting for an acknowledgement until a re-transmission of the control data is triggered, maximum time allowed for the transmission of control data, maximum number of simultaneous active connections between the provisioning control system 120 and the provisioning network node 135, maximum time to wait for establishing new connections between the provisioning control system and the provisioning network node, and re-transmission factor for linear scaling of time period between re-transmission attempts.

According to another embodiment, the settings for a first of the one or more previous transmissions are stored linked to the characteristics of the first previous transmission. By storing the settings and characteristics for one and the same previous transmission linked to each other, it is expedient to automatically determine settings for new transmissions based on this particular previous transmission as the outcome in terms of characteristics of using a certain settings for the transmission is directly relating to the settings used.

According to another embodiment, the transmission settings for the current transmission are determined 208 using a machine learning algorithm on the transmission settings and the transmission characteristics of the one or more previous transmissions. Hereby, the settings of the current transmission may be automatically and dynamically adapted to data of the previous settings and characteristics. Machine learning is a method of data analysis used in computer science that applies statistical techniques to large amounts of data, looking for the best pattern to solve a predefined problem. Machine learning algorithms iteratively learn from input data and operate by building a model from an example training set of input observations in order to make data-driven predictions. The iterative aspect of machine learning is important because as models are exposed to new data, they are able to independently adapt. It learns from previous computations to produce reliable, repeatable decisions and results.

According to a variant of this embodiment, the machine learning algorithm could be combined with a decision model support. In other words, the results of handling input data in a machine learning algorithm can be further input to a decision model support, such as a fuzzy decision making system, in order to handle the possibility of constructing a decision model from a set of vague data. Hereby, the determination of the transmission settings based on previous transmissions could be even further improved. In fuzzy set theory, the input variables have degrees of membership. For instance, if value 1 is assigned to variables entirely within the set and 0 to those outside, any variable partially in the set will be assigned a value between 0 and 1. In fuzzy decision-making, there are given a set of linguistic rules for relating the fuzzy sets and their member variables. There can be any number of input and output membership functions for the same input. For example, a system could have membership functions that represent slow, medium, and fast or cold, warm and hot as possible inputs.

According to another embodiment, the transmission settings for the current transmission are determined 208 taking into account a preset transmission criteria, such as minimizing blocking time of a transmission channel between the provisioning control system 120 and the provisioning network node 135 due to the current transmission. Another preset transmission criteria may be to prioritize certain types of transmissions, such as RP transmissions. By being able to determine the transmission settings for the current transmission based on a preset criterion, the transmission settings can be adapted so that they fulfil criteria that may have different goals.

According to another embodiment, the method further comprises, for a first of the one or more previous transmissions, setting 202 first values of transmission settings, triggering transmission 204 of control data to the provisioning network node 135 using the first transmission setting values, and obtaining 206 the transmission characteristics for the first previous transmission as a result of the transmission 204 using the first transmission settings values. Further, the determining 208 of transmission settings for a current transmission is performed based on the first values of transmission settings and the obtained transmission characteristics for the first previous transmission. The transmission characteristics of the first previous transmission may be measured by the provisioning network node 135 and sent to the provisioning control system 120 and/or they may be measured by the provisioning control system 120 on signals sent from the provisioning network node 135, such as for determining round trip delay. Hereby, a possible way of receiving transmission settings and transmission characteristics for previous transmissions is shown. These data can then easily be stored by the provisioning control system.

According to another embodiment, the provisioning control system 120 is in a learning mode when setting the first values, triggering transmission and obtaining the transmission characteristics for the first transmission. To be in a learning mode may signify that the provisioning control system is in a simulation mode, i.e. that the system does not control provisioning of services to real users in a working communication network, but instead the system is simulated for different use cases. Hereby, different settings can be tested to see the outcome as transmission characteristics before the settings are taken into use on a working network. Also, in a learning mode, settings that are normally not used in a working network can be tested to see the outcome.

According to another embodiment, the transmission settings for the current transmission is further determined based on information on the current transmission. Information on the current transmission may be current network conditions such as network response times and transmission rate over a link between the provisioning control system and the provisioning network node, but also characteristics of the payload to be sent in the current transmission, such as type of payload, amount of payload and/or a measure defining a priority of the payload to be sent, such as how time-critical the payload to be sent is, etc. Hereby it is possible to take information that we already have for the current transmission into account when determining the settings for the current transmission based on the settings and characteristics for previous transmissions. Such information that we already have for the current transmission could be compared to similar information for previous transmission. For example, a type of payload that is to be sent now may be transmitted with similar settings as for an earlier transmission of the same type of payload, or such a previous transmission of the same type of payload may be weighted higher when selecting settings for a current transmission than a previous transmission of a different type of payload than the payload of the current transmission. As a further example, for a complex service order involving several nodes and that is prone to partial provisioning; a more persistent transmission setting may be selected as compared to a simpler service order destined for only one node.

According to another embodiment, intelligence is added in a provisioning control system for determining settings for transmission of control data from the provisioning control system to a provisioning node. This is performed by analyzing current network conditions with regards to for example current provisioning node response times, response codes and/or current transmission rate and correlate the current network conditions with previous transmission settings and characteristics, including conditions, for previous transmissions of control data towards the provisioning node in order to determine transmission settings for a current transmission. This may be done by implementing a new logical module into the provisioning control system that apply machine learning concepts onto input data, such as previous transmission settings and characteristics and current network conditions, in order to determine transmission settings for a current transmission. By implementing a machine learning algorithm, e.g. a Neural Network, NN, algorithm, onto the input data, which algorithm may be combined with a decision model support, e.g. Analytical Hierarchy Process, AHP, or a Fuzzy logic model, will enable dynamically setting parameters (also called settings) for current transmissions of control data from the provisioning control system towards the provisioning node.

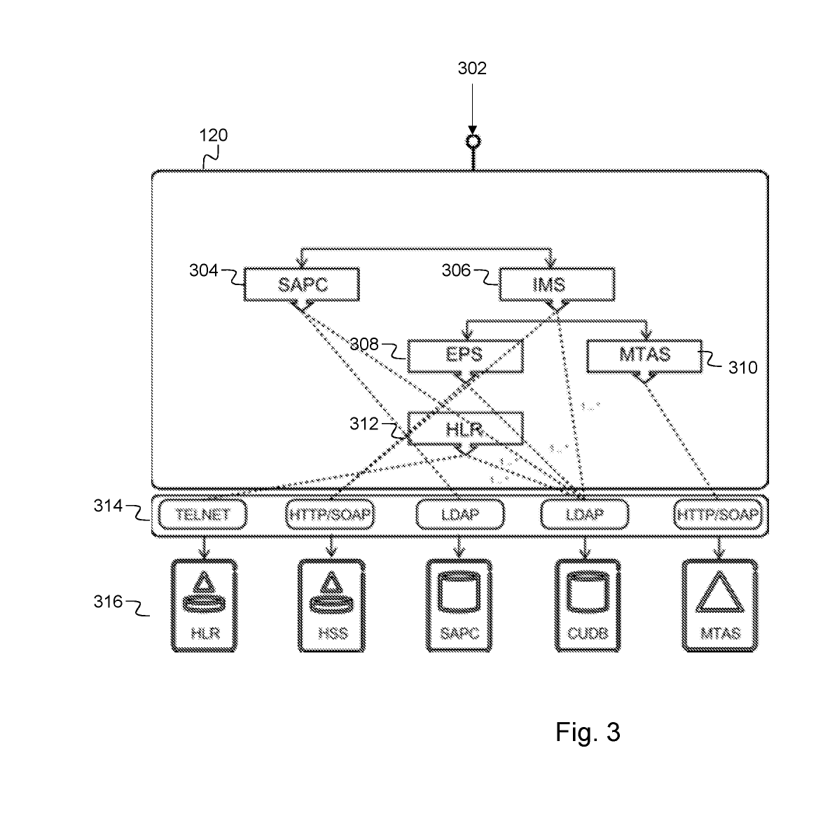

One example where benefits of embodiments described in this disclosure is evident, is for provisioning of VoLTE subscribers to the core network. This is considered as a complex service order where one service order is decomposed into multiple provisioning domains, which in turn performs one or multiple interactions with multiple core network nodes. Provisioning of VoLTE subscribers to the core network is shown in FIG. 3. The provisioning control system 120 receives a service order, at 302, for creation of VoLTE subscription data for a number of subscribers. The service order is decomposed into provisioning data for different domains, illustrated by provisioning data for Service Aware Policy Controller, SAPC, 304, provisioning data for IP Multimedia Subsystem, IMS, 306, provisioning data for Evolved Packet System, EPS, 308, for MTAS 310 and for Home location Register, HLR 312. The provisioning data for the different domains are then sent via different connectors 314 to core network nodes 316, e.g. HLR, Home subscriber system, HSS, SAPC, CUDB, MTAS. In such scenario it is crucial that the connectivity towards the core network nodes are robust and that optimum connection properties are dynamically maintained over time to cater for temporary impairments in the network. This in order to minimize the risk of partial provisioning of subscribers/services, i.e. where the core network nodes are no longer in sync or left in an inconsistent state, which requires complex reconciliation operations.

According to an embodiment, the transmission settings for a current/new transmission of control data may be automatically tuned based on customer preferences such as to minimize blocking time for other transmissions from the provisioning control system to the provisioning node due to the current transmission, e.g. to minimize an RP blocking time. This signifies that a request for provisioning new data towards the provisioning node is only accepted if the new data is determined to be transmitted within a certain period of time, e.g. within a configured response timeout in the business support system, BSS, or an operations support system, OSS. According to another embodiment, the transmission settings for a current/new transmission of control data may be automatically tuned based on customer preferences such as to execute the current transmission of control data at any cost, i.e. ongoing service orders are first completed prior to initiating the current/new transmission of control data, e.g. the new RP operation, and new service orders received from the BSS/OSS are rejected until the new transmission of control data is completed.

As mentioned, the intelligence in the proposed module for dynamically handling provisioning of control data to provisioning nodes is achieved by implementing in the provisioning control system, a machine learning algorithm (or model), as for instance one of any NN algorithms, e.g., the Multilayer Perceptron, MLP, algorithm or the Bayesian Neural Network, BNN, algorithm, on the input data. By combining the machine learning algorithm with a decision model support implementation, such as AHP or a Fuzzy logic model adaptation, dynamically setting parameters for the transmission of control data from the provisioning control system towards a provisioning network node is further enabled. In machine learning, for every considered algorithm or method chosen, there are usually a number of key configuration parameters which have to be determined with care. The key parameters are the ones controlling the complexity of the machine learning algorithm. Oftentimes, these parameters are called “model selection” parameters. Such selection parameters denote the number of input variables given to the machine learning algorithm, for example the size of network, as for the case of MLP and BNN.

When selecting parameters for the algorithm, the main approach in machine learning concept is to use so-called k-fold validation. The k-fold validation is used for training the machine learning algorithm based on the available configuration (or test) data, also called a training set. In k-fold validation, the training set is divided into k equal parts, also called “folds”. The algorithm is then trained using the data in the k-1 folds and validated on the remaining kth fold. Then the validation fold is rotated and the same procedure is repeated again and performed k times. The total sum of the validation errors obtained in each k fold is then computed. This becomes the validation error that will later be used as a criterion for selecting the key configuration parameters.

In general, for each algorithm (aka. method), there are two parameters that may have to be determined using the k-fold approach: the number of input variables for the algorithm, and the parameter determining algorithm's complexity, e.g., the number of hidden nodes in MLP. The network response times for provisioning requests may be a parameter that will be used in a machine learning algorithm of embodiments of the present invention.

Naturally, before choosing the most appropriate parameters for the machine learning algorithm according to the embodiment, it may be necessary to first test how the algorithm would perform according to relevant provisioning parameters as well as the nature of the parameters. For example, it may be needed to see if the parameters possess trends or if they are non-trending since such factors will directly influence the computational demands and the performance and accuracy of the chosen parameters for the algorithm. This would likely be the most important consideration when deciding the proper parameters for the machine learning algorithm while at the same time it may be needed to consider real life provisioning scenarios, e.g., a demanding parameter tuning step

According to an embodiment, the provisioning control system is arranged for executing the provisioning operations, i.e. for transmitting the service provisioning control data towards the provisioning network node, and for logging the results, i.e. the transmission characteristics. The system makes decisions depending on the events triggered, providing reports or auto-tuning to the system. The system may have a storage in which interesting configuration parameters, i.e. transmission settings, are kept up to date with new suggested values.

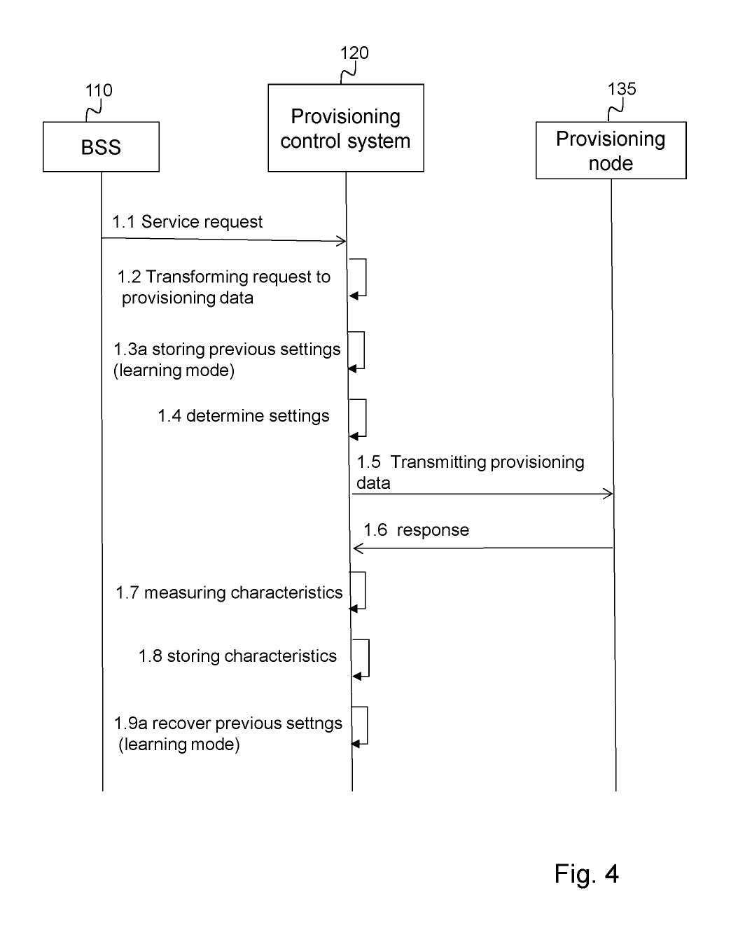

FIG. 4 shows a signaling diagram describing a method according to an embodiment. In the method of FIG. 4, the provisioning control system gets 1.1 a service request, either from the BSS (as in FIG. 4) or as an external trigger (not shown), e.g. from a newly added provisioning node. Then the service request is transformed 1.2 into provisioning data by the provisioning control system. From the provisioning data, the new module of the provisioning control system reads out whether the system is in learning mode or whether the system is in running mode, i.e. whether the provisioning node is to be auto-tuned in runtime. When in learning mode, the provisioning control system stores 1.3a previously used provisioning settings. Then the provisioning control system determines 1.4 the provisioning settings for a transmission of the provisioning data based on stored earlier transmission settings and characteristics and possibly also based on information on the new transmission. Thereafter, the provisioning data is transmitted 1.5 to the provisioning node according to the determined provisioning settings. Thereafter, characteristics of the transmission of the provisioning data is measured 1.7 at the provisioning control system. The provisioning node may respond 1.6 to the received provisioning data by e.g. an acknowledgement on which the provisioning control system may measure round-trip time. The characteristics measured at the provisioning control system is stored 1.8 at the provisioning control system. When the system is in learning mode, the provisioning control system may recover 1.9a the stored previously used provisioning settings (stored at 1.3a). The steps having a suffix “a” are only performed when in training mode. When in training mode, the provisioning control system can decide whether to use the determined provisioning settings for new transmissions of control data to the provisioning node or not.

According to an embodiment, interim response failures from a provisioning node are resolved by performing x number of retransmissions of the control data to the provisioning node before aborting the corresponding request. The number of retransmissions to be performed before aborting is according to prior art defined by a static configuration of the connectivity properties of a provisioning node. By instead allowing dynamic configuration of such parameters, for example in the event of introducing a new provisioning node (i.e. tune event), it is possible to go into learning mode and probe for the optimum configuration values. For example counting the number of retry attempts necessary in order to resolve from interim response failures. The number of allowed retransmissions may be determined based on previous transmission of control data from the provisioning control system to the provisioning node. In the previous transmissions the number of retry attempts necessary in order to resolve from interim response failures are counted by the provisioning node and reported to the provisioning control system.

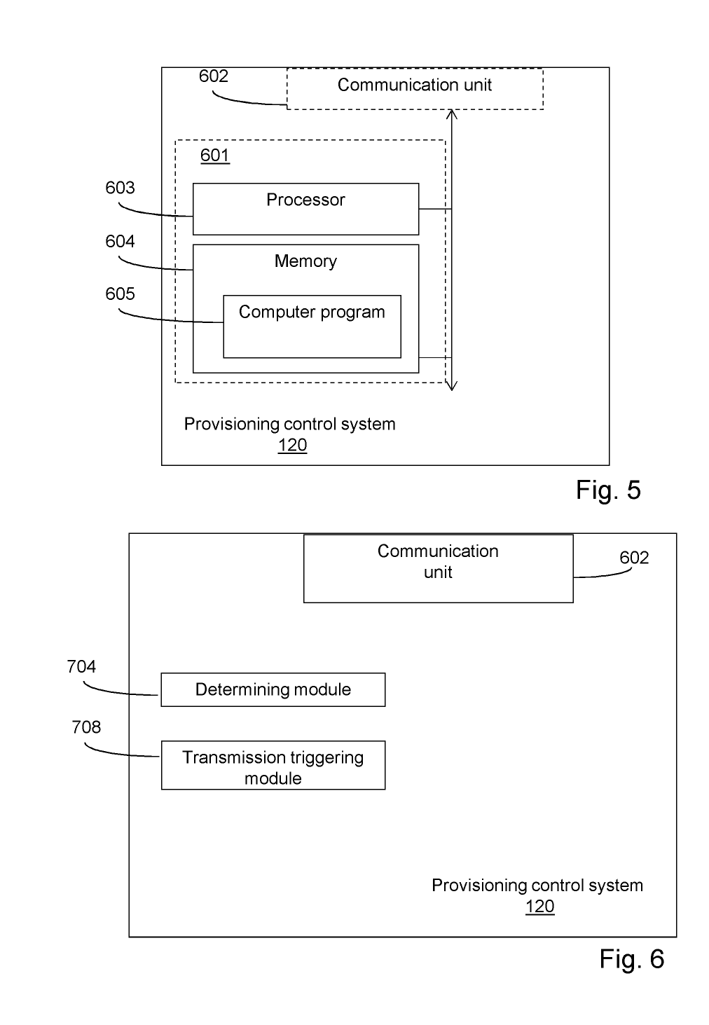

FIG. 5, in conjunction with FIG. 1, describes a provisioning control system 120 operable in a communication network 100, configured for controlling provisioning of services from a provisioning network 130 of the communication network to communication devices 150 belonging to subscribers of the communication network. The provisioning control system 120 comprising a processor 603 and a memory 604. The memory contains instructions executable by said processor, whereby the provisioning control system 120 is operative for determining transmission settings for a current transmission of control data from the provisioning control system to a node 135 of the provisioning network, the control data controlling provisioning of services from the provisioning network to communication devices 150, wherein the transmission settings for the current transmission are determined based on transmission settings and transmission characteristics of one or more previous transmissions of control data from the provisioning control system 120 to the provisioning network node 135. The provisioning control system 120 is further operative for triggering the current transmission of the control data to the provisioning network node 135 according to the determined transmission settings.

The provisioning control system may be realized by only one communication network node. Alternatively, the provisioning control system may be realized by a group of network nodes, wherein functionality of the provisioning control system is spread out over the different physical, or virtual nodes of the group. The latter may be called a “cloud-solution”.

According to an embodiment, the provisioning control system 120 is further operative for storing the settings for a first of the one or more previous transmissions linked to the characteristics of the first previous transmission.

According to another embodiment, the provisioning control system 120 is operative for determining the transmission settings for the current transmission using a machine learning algorithm on the transmission settings and the transmission characteristics of the one or more previous transmissions.

According to another embodiment, the provisioning control system 120 is operative for determining the transmission settings for the current transmission using a machine learning algorithm combined with a decision model support on the transmission settings and the transmission characteristics of the one or more previous transmissions.

According to another embodiment, the provisioning control system 120 is operative for determining the transmission settings for the current transmission taking into account a preset transmission criterion, such as minimizing blocking time of a transmission channel between the provisioning control system 120 and the provisioning network node 135 due to the current transmission.

According to another embodiment, the provisioning control system 120 is further operative for, for a first of the one or more previous transmissions, setting first values of transmission settings, triggering transmission of control data to the provisioning network node 135 using the first transmission setting values, and obtaining the transmission characteristics for the first previous transmission as a result of the transmission using the first transmission settings values, and wherein the provisioning control system is operative for determining the transmission settings for a current transmission based on the set first values of transmission settings and the obtained transmission characteristics for the first previous transmission.

According to another embodiment, the provisioning control system 120 is configured to be in a learning mode when setting the first values, triggering transmission and obtaining the transmission characteristics for the first transmission.

According to another embodiment, the provisioning control system 120 is operative for determining the transmission settings for the current transmission also based on information on the current transmission.

According to other embodiments, the provisioning control system 120 may further comprise a communication unit 602, which may be considered to comprise conventional means for communicating with other nodes of the network, such as the BSS or the provisioning nodes. The instructions executable by said processor 603 may be arranged as a computer program 605 stored e.g. in said memory 604. The processor 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above.

The computer program 605 may comprise computer readable code means, which when run in the provisioning control system 120 causes the provisioning control system 120 to perform the steps described in any of the described embodiments of the provisioning control system. The computer program 605 may be carried by a computer program product connectable to the processor 603. The computer program product may be the memory 604. The memory 604 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604. Alternatively, the computer program may be carried by an electronic signal, optical signal or a radio signal. Alternatively, the computer program may be stored on a server or any other entity connected to the communication network to which the provisioning control system 120 has access via the communication unit 602. The computer program may then be downloaded from the server into the memory 604.

FIG. 6, in conjunction with FIG. 1, shows another embodiment of a provisioning control system 120 operable in a communication network 100, configured for controlling provisioning of services from a provisioning network 130 of the communication network to communication devices 150 belonging to subscribers of the communication network. The provisioning control system 120 comprising a determining module 704 for determining transmission settings for a current transmission of control data from the provisioning control system to a node 135 of the provisioning network, the control data controlling provisioning of services from the provisioning network to communication devices 150. The transmission settings for the current transmission are determined based on transmission settings and transmission characteristics of one or more previous transmissions of control data from the provisioning control system 120 to the provisioning network node 135. The provisioning control system 120 further comprises a triggering module 706 for triggering the current transmission of the control data to the provisioning network node 135 according to the determined transmission settings. The provisioning control system 120 may further comprise a communication unit 602 similar to the communication unit of FIG. 5.

At least some of the above described embodiments provides a possibility to dynamically predict provisioning control settings to be used when performing complex provisioning tasks with multiple interactions towards the provisioning nodes. Further, by having dynamic dimensioning guidelines, the dimensioning performance of the provisioning control system may be improved. Another advantage with one or more of the above described embodiments is that new or upgraded installations can automatically get proper network connectivity configuration. Further, Provisioning tasks can get consistent and predictable performance, resulting in minimal partial provisioning issues.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a provisioning control system of a communication network, the provisioning control system controlling provisioning of services from a provisioning network of the communication network to communication devices belonging to subscribers of the communication network, the method comprising:
determining transmission settings for a current transmission of control data from the provisioning control system to a node of the provisioning network, the control data controlling provisioning of services from the provisioning network to communication devices, the transmission settings for the current transmission being determined based on transmission settings and transmission characteristics of at least one previous transmission of control data from the provisioning control system to the provisioning network node; and
triggering the current transmission of the control data to the provisioning network node according to the determined transmission settings.

2. The method according to claim 1, wherein the transmission characteristics for the at least one previous transmission comprises at least one selected from the group consisting of: previous network response times, number of performed re-transmissions, number of simultaneous active connections, actual transmission rate, actual round-trip delay, specific error response codes, and characteristics of the payload that was sent.

3. The method according to claim 1, wherein the settings for the current transmission and the settings for the at least one previous transmission comprises at least one selected from the group consisting of: maximum number of allowed re-transmissions for the control data, time period for waiting for an acknowledgement until a re-transmission of the control data is triggered, maximum time allowed for the transmission of control data, maximum number of simultaneous active connections between the provisioning control system and the provisioning network node, maximum time to wait for establishing new connections between the provisioning control system and the provisioning network node, and re-transmission factor for linear scaling of time period between re-transmission attempts.

4. The method according to claim 1, wherein the settings for a first of the at least one previous transmission are stored linked to the characteristics of the first previous transmission.

5. The method according to claim 1, wherein the transmission settings for the current transmission are determined using a machine learning algorithm on the transmission settings and the transmission characteristics of the at least one previous transmission.

6. The method according to claim 5, wherein the transmission settings for the current transmission are determined using a machine learning algorithm combined with a decision model support on the transmission settings and the transmission characteristics of the at least one previous transmission.

7. The method according to claim 1, wherein the transmission settings for the current transmission are determined taking into account a preset transmission criterion, the previous transmission criterion including minimizing blocking time of a transmission channel between the provisioning control system and the provisioning network node due to the current transmission.

8. The method according to claim 1, further comprising, for a first of the at least one previous transmission:
setting first values of transmission settings;
triggering transmission of control data to the provisioning network node using the first transmission setting values; and
obtaining the transmission characteristics for the first previous transmission as a result of the transmission using the first transmission settings values, and wherein the determining of transmission settings for a current transmission is performed based on the set first values of transmission settings and the obtained transmission characteristics for the first previous transmission.

9. The method according to claim 8, wherein the provisioning control system is in a learning mode when setting the first values, triggering transmission and obtaining the transmission characteristics for the first transmission.

10. The method according to claim 1, wherein the transmission settings for the current transmission is further determined based on information on the current transmission.

11. A provisioning control system operable in a communication network, the provisioning control system being configured for controlling provisioning of services from a provisioning network of the communication network to communication devices belonging to subscribers of the communication network, the provisioning control system (120) comprising a processor and a memory, said memory containing instructions executable by said processor, the provisioning control system being configured to:
determine transmission settings for a current transmission of control data from the provisioning control system to a node of the provisioning network, the control data controlling provisioning of services from the provisioning network to communication devices, the transmission settings for the current transmission being determined based on transmission settings and transmission characteristics of at least one previous transmission of control data from the provisioning control system to the provisioning network node; and
trigger the current transmission of the control data to the provisioning network node according to the determined transmission settings.

12. The provisioning control system according to claim 11, being further configured to store the settings for a first of the at least one previous transmission linked to the characteristics of the first previous transmission.

13. The provisioning control system according to claim 11, further configured to determine the transmission settings for the current transmission using a machine learning algorithm on the transmission settings and the transmission characteristics of the at least one previous transmission.

14. The provisioning control system according to claim 13, further configured to determine the transmission settings for the current transmission using the machine learning algorithm combined with a decision model support on the transmission settings and the transmission characteristics of the at least one previous transmission.

15. The provisioning control system according to claim 11, further configured to determine the transmission settings for the current transmission taking into account a preset transmission criterion, the previous transmission criterion including minimizing blocking time of a transmission channel between the provisioning control system and the provisioning network node due to the current transmission.

16. The provisioning control system according to claim 11, being further configured to, for a first of the one at least one previous transmission:
set first values of transmission settings;
trigger transmission of control data to the provisioning network node using the first transmission setting values; and
obtain the transmission characteristics for the first previous transmission as a result of the transmission using the first transmission settings values, and wherein the provisioning control system is configured to determine the transmission settings for a current transmission based on the set first values of transmission settings and the obtained transmission characteristics for the first previous transmission.

17. The provisioning control system according to claim 16, configured to be in a learning mode when setting the first values, triggering transmission and obtaining the transmission characteristics for the first transmission.

18. The provisioning control system according to claim 17, further configured to determine the transmission settings for the current transmission also based on information on the current transmission.

19. A computer storage medium storing a computer program comprising computer readable code executable by a provisioning control system of a communication network, the provisioning control system being configured for controlling provisioning of services from a provisioning network of the communication network to communication devices belonging to subscribers of the communication network, the computer readable code when executed by the provisioning control system causes the provisioning control system to:
determine transmission settings for a current transmission of control data from the provisioning control system to a node of the provisioning network, the control data controlling provisioning of services from the provisioning network to communication devices, the transmission settings for the current transmission being determined based on transmission settings and transmission characteristics of at least one previous transmission of control data from the provisioning control system to the provisioning network node; and
trigger the current transmission of the control data to the provisioning network node according to the determined transmission settings.

20. (canceled)

21. A provisioning control system operable in a communication network, the provisioning control system being configured for controlling provisioning of services from a provisioning network of the communication network to communication devices belonging to subscribers of the communication network, the provisioning control system (120) comprising a processor and a memory, said memory containing instructions executable by said processor, the provisioning control system comprising:
a determining module for determining transmission settings for a current transmission of control data from the provisioning control system to a node of the provisioning network, the control data controlling provisioning of services from the provisioning network to communication devices, the transmission settings for the current transmission being determined based on transmission settings and transmission characteristics of at least one previous transmission of control data from the provisioning control system to the provisioning network node; and a triggering module for triggering the current transmission of the control data to the provisioning network node according to the determined transmission settings.
